(19) United States
(12) Patent Application Publication
(10) Pub. No.: US 2021/0337714 A1
(43) Pub. Date: Nov. 4, 2021

(54) APPARATUS FOR CLEARING TRASH FROM A SOIL SURFACE

(71) Applicant: C.S. Gent & Sons LTD., Sutton St Edmunds (GB)

(72) Inventor: Anthony Gent, Spalding Lincolnshire (GB)

(73) Assignee: C.S. Gent & Sons LTD., Sutton St Edmunds (GB)

(21) Appl. No.: 17/268,871

(22) PCT Filed: Jul. 24, 2019
(86) PCT No.: PCT/EP2019/069918

§ 371 Date: Feb. 16, 2021

(30) Foreign Application Priority Data
Aug. 17, 2018 (GB) 1813428.8

(51) Int. Cl. A01B 35/16; A01B 49/06; A01C 7/00; A01C 21/00; A01C 23/02

(52) U.S. Cl. CPC A01B 35/16; A01B 49/06; A01C 23/021; A01C 21/002; A01C 7/006

(57) ABSTRACT

An apparatus for clearing trash from a soil surface, the apparatus being configured to be mounted on a towable frame support and driven across the soil surface in a direction of travel (“D”), the apparatus comprising: a bearing housing; and a soil-engaging member rotatably mounted to the support, wherein the soil-engaging member is oriented to rotate about an axis (“A”) tilted from a perpendicular to the soil surface (“B”) by an acute angle (Φ1) towards one lateral side relative to the direction of travel (“D”), whereby contact between the soil-engaging member and the soil surface induces rotation of the soil-engaging member around the axis (“A”).

### CROSS-REFERENCE TO RELATED APPLICATIONS

This application is a national phase entry under 35 U.S.C. § 371 of International Patent Application PCT/EP2019/069918, filed Jul. 24, 2019, designating the United States of America and published as International Patent Publication WO 2020/035274 A1 on Feb. 20, 2020, which claims the benefit under Article 8 of the Patent Cooperation Treaty to Great Britain Patent Application Serial No. 1813428.8, filed Aug. 17, 2018.

### TECHNICAL FIELD

The present disclosure relates to an apparatus for clearing trash from a soil surface, and particularly, but not exclusively, to an apparatus configured to be used without any form of cooperating scraper.

### BACKGROUND

With the reduction of inversion soil tillage such as min-till, strip-till, no-till and zero-till, often the previous crop residue or weed growth is present on the surface at the time of sowing the next crop. This can cause problems with surface tillage or seed sowing operations due to crop residue and weeds (hereinafter “trash”) becoming entangled with ground-engaging parts of the cultivator or seed drill. Also, particularly with seeding operations that are carried out using rotating soil openers such as cutting discs, trash present on the soil surface can be deflected into the soil by the periphery edge of the cutting disc as it enters the soil to create an opening for seed to be placed, resulting in unwanted organic material being introduced into the opening and coming into contact with the seed. This is known as “hair-pinning” and causes problems of rotting and/or toxicity with seed, which then has a detrimental effect on germination, establishment and growth of the crop. It is therefore highly desirable prior to performing cultivating or sowing operations to mechanically clear the soil surface of trash along the path of the cultivating or seed sowing tool. This is particularly important in soft or wet soil conditions as the trash is more likely to be pushed into the soil than cut through and left on the surface.

Known methods for displacing trash typically involve the use of ground-driven toothed wheels or concave discs mounted to rotate about a horizontal axis. The horizontal axis are typically angled relative to the direction of travel with the ground-engaging part of the wheel or disc coming into contact with the soil surface ahead and line with the cultivating or sowing device. The problem with these wheel and disc arrangements is that it is difficult to achieve an area of sufficient width without a degree of entry into the soil due to the radius effect causing a curvature at point of contact with the soil and limitation of angle to the direction of travel because of the need for sufficient ground contact to induce self-rotation. Too great an angle causes excessive distance of material throw, especially at higher speeds. Some of these problems can be overcome by using pairs of toothed wheel or concave disc arrangements per row, usually set to displace the material to opposed lateral directions. This still has the complication of uncontrolled throw and increases the complexity and cost.

The present applicant has identified the need for an improved trash clearance device that overcomes or at least alleviates problems associated with the prior art.

### BRIEF SUMMARY

In accordance with a first aspect of the present disclosure, there is provided apparatus for clearing trash (e.g., crop residue or weeds) from a soil surface, the apparatus being configured to be mounted on a towable frame support and driven across the soil surface in a direction of travel, the apparatus comprising: a support; and a soil-engaging member (e.g., tool or share) rotatably mounted to the support, wherein the soil-engaging member is oriented to rotate about an axis tilted from a perpendicular to the soil surface by an acute angle (e.g., first acute angle) towards one lateral side relative to the direction of travel, whereby contact between the soil-engaging member and the soil surface induces rotation of the soil-engaging member around the axis.

In this way, a near upright self-rotating soil surface scraper/soil surface residue remover is provided for use in clearing trash from along a furrow path or clearing weeds between adjacent furrows. Advantageously, the upright position of the soil-engaging member provides an effective trash clearance action with minimal soil disruption.

Typically, the soil-engaging member is configured to operate without the interaction of a cooperating device to achieve trash clearance. For example, the soil-engaging member may be configured to operate to clear trash without the need for a cooperating scraper (e.g., a scraperless trash clearing apparatus).

In one embodiment, the acute angle is in the range 10°-35° (e.g., 15°-25°).

In one embodiment, the axis is additionally tilted at a second acute angle towards the front relative to the direction of travel.

In one embodiment, the second acute angle is in the range 10°-35° (e.g., 15°-25°).

In one embodiment, the first acute angle is substantially equal to the second acute angle.

In one embodiment, the soil-engaging member comprises a central shaft.

In one embodiment, the support comprises a bearing housing comprising a bearing operative to rotatably support an (e.g., upper) end part of the central shaft (e.g., end shaft) of the soil-engaging member.

In one embodiment, the soil-engaging member defines a trash displacement surface operative to displace trash to one lateral side relative to the direction of travel.

In one embodiment, the central shaft defines a passageway (e.g., delivery passageway) for delivering material (e.g., particulate material such as seed or fertilizer or a liquid) to an outlet (e.g., outlet provided on the central shaft).

In one embodiment, the outlet is located at a lowermost part of the central shaft. Depending upon the length of the central shaft the outlet may be located at or near a lowermost portion of the soil-engaging member or at a position raised from the lowermost portion.

In one embodiment, the soil-engaging member defines a rotary body (e.g., defining the trash displacement surface) connected to the central shaft.

In one embodiment, the rotary body defines a further passageway for receiving material from the passageway in the central shaft. In this embodiment, the outlet may be provided on the rotary body (e.g., provided at a lowermost portion of the rotary body).

In one embodiment, the further passageway is configured to receive a lower end of the central shaft.

In one embodiment, the central shaft (e.g., end part of the central shaft) defines an inlet for receiving material from a delivery tube.

In one embodiment, the apparatus further comprises a connector for connecting the delivery tube to the support or to the soil-engaging member.

In one embodiment, the connector comprises a bracket for mounting the delivery tube to the support (e.g., to the bearing housing).

In one embodiment, the connector further comprises a connecting part having a leading end configured to extend into the passageway of the central shaft and deliver material from the delivery tube into the passageway. In one embodiment, a trailing end of the connecting part is configured to extend into the delivery tube.

In one embodiment, a lower part of the central shaft forms a central elongate stem.

In one embodiment, the trash displacement surface is provided at a lower portion (e.g., lowermost portion) of the soil-engaging member and separated from the support by the central elongate stem.

In one embodiment, the central elongate stem defines an area of revolution substantially smaller than an effective (e.g., mean) area of revolution of the support (i.e., the area of the swept shape formed by rotation of radially outermost parts of the central elongate stem when rotating around the axis is substantially smaller in area than the equivalent swept shape that would be formed by rotation of radially outermost parts of the support about the same axis).

In one embodiment, the trash displacement surface is configured to deflect away trash attempting to rise up the soil-engaging member. In this way, the trash displacement member is configured to keep trash low and away from the support (e.g., by deflecting the trash downwards or sideways).

In one embodiment, a degree of trash deflection is achieved by providing the trash displacement surface that extends from a lower portion (e.g., lowermost portion) of the body to an upper portion (e.g., uppermost potion) adjacent the support. In one embodiment, an upper portion of the trash displacement surface may longitudinally overlap a leading portion of the support.

In one embodiment, an upper portion (e.g., uppermost portion) of the trash displacement surface defines an area of revolution (i.e., area of the swept shape formed by rotation of radially outermost parts of the surface when rotating around the axis) substantially equal to or greater than an effective (e.g., mean) area of revolution of the support.

In one embodiment, the trash displacement surface has an area of revolution that increases with reduced distance from the support (e.g., increasing from a lower portion (e.g., lowermost portion) to an upper portion (e.g., uppermost portion)).

In one embodiment, the change in the area of revolution between the lower portion (e.g., lowermost portion) and the upper portion (e.g., uppermost portion) is associated with a substantially constant taper angle. In one embodiment, the taper angle is in the range 10°-35° (e.g.,) 15°-25°. In one embodiment, the taper angle is substantially equal to the first angle.

In a first set of embodiments, the trash displacement surface is a continuous surface.

In one embodiment, the trash displacement surface is a substantially cylindrical surface.

In one embodiment, the trash displacement surface is a frusto-conical surface. In one embodiment, the frusto-conical surface is oriented such that the cross-sectional area (and hence area of revolution) of the frusto-conical surface increases with reduced distance from the support (e.g., increases from a lower portion to an upper portion).

In a second set of embodiment, the trash displacement surface is a discontinuous surface.

In one embodiment, the trash displacement surface comprises a plurality of circumferentially-spaced projections.

In one embodiment, the trash displacement surface comprises a plurality of circumferentially-spaced vanes extending radially from a central stem.

In one embodiment, the vanes have a radial length that increases with reduced distance from the support (e.g., increases from a lower portion of the vane to an upper portion of the vane, e.g., to define a frusto-conical profile when rotating).

In one embodiment, the plurality of vanes comprises 3 or more vanes (e.g., 4 or more vanes).

In one embodiment, the vanes are substantially equally spaced circumferentially.

In one embodiment, an upper portion of the vanes encloses a leading portion of the support.

In one embodiment, the trash displacement surface comprises a plurality of circumferentially spaced axially extending tines extending from a support frame (e.g., extending downwards from an upper support frame).

In one embodiment, the support frame comprises a plurality of radially extending arm portions, each arm portion supporting an individual tine.

In one embodiment, the plurality of tines comprises 3 or more tines (e.g., 4 or more tines).

In one embodiment, the tines are substantially equally spaced circumferentially.

In one embodiment, a lowermost part of the soil-engaging member defines a protuberant cutting rim (e.g., circular disc or plate) projecting from a central body portion of the member and configured to partially penetrate the soil (e.g., to a pre-defined first depth). Typically, the central body portion of the member defines a trash displacement surface (e.g., as previously defined). In another embodiment, the central body portion of the member comprises a stem supporting the protuberant cutting rim.

In one embodiment, the apparatus further comprises a trailing arm assembly mounted to the support and operative to allow the soil engaging member to follow ground contour variations. In one embodiment, the trailing arm assembly is operative to maintain a predetermined orientation of the axis relative to the ground. For example, the trailing arm assembly may comprise a parallel linkage assembly.

In one embodiment, the apparatus is biased to maintain a downward force on soil-engaging member (e.g., to maintain suitable ground pressure). The biasing action may be provided by one or more of a spring bias device, a hydraulic bias device, and a pressurized air bias device.

In accordance with a second aspect of the present disclosure, there is provided a frame assembly for towing along a soil surface on which there is mounted an apparatus for clearing trash as defined in any embodiment of the first aspect of the present disclosure.

### BRIEF DESCRIPTION OF THE DRAWINGS

Embodiments of the present disclosure will now be described by way of example with reference to the accompanying drawings wherein:

FIG. 1A is a schematic front view of a trash clearing assembly in accordance with a first embodiment of the present disclosure;

FIG. 1B is a schematic side view of the trash clearing assembly of FIG. 1A;

FIG. 2A is a schematic front view of a trash clearing assembly in accordance with a second embodiment of the present disclosure;

FIG. 2B is a schematic side view of the trash clearing assembly of FIG. 2A;

FIG. 3A is a schematic front view of a trash clearing assembly in accordance with a third embodiment of the present disclosure;

FIG. 3B is a schematic side view of the trash clearing assembly of FIG. 3A;

FIG. 4A is a schematic front view of a trash clearing assembly in accordance with a fourth embodiment of the present disclosure;

FIG. 4B is a schematic side view of the trash clearing assembly of FIG. 4A;

FIG. 5A is a schematic front view of a trash clearing assembly in accordance with a fifth embodiment of the present disclosure;

FIG. 5B is a schematic side view of the trash clearing assembly of FIG. 5A;

FIG. 6A is a schematic front view of a trash clearing assembly in accordance with a sixth embodiment of the present disclosure;

FIG. 6B is a schematic side view of the trash clearing assembly of FIG. 6A;

FIG. 7A is a schematic front view of a trash clearing assembly in accordance with a seventh embodiment of the present disclosure;

FIG. 7B is a schematic side view of the trash clearing assembly of FIG. 7A;

FIG. 8A is a schematic front view of a trash clearing assembly in accordance with an eighth embodiment of the present disclosure;

FIG. 8B is a schematic side view of the trash clearing assembly of FIG. 8A;

FIG. 9A is a schematic side view of a trash clearing assembly in accordance with a further embodiment of the present disclosure including material delivery functionality; and

FIG. 9B is a schematic cross-sectional view of parts of the trash clearing assembly of FIG. 9A illustrating the material delivery functionality.

### DETAILED DESCRIPTION

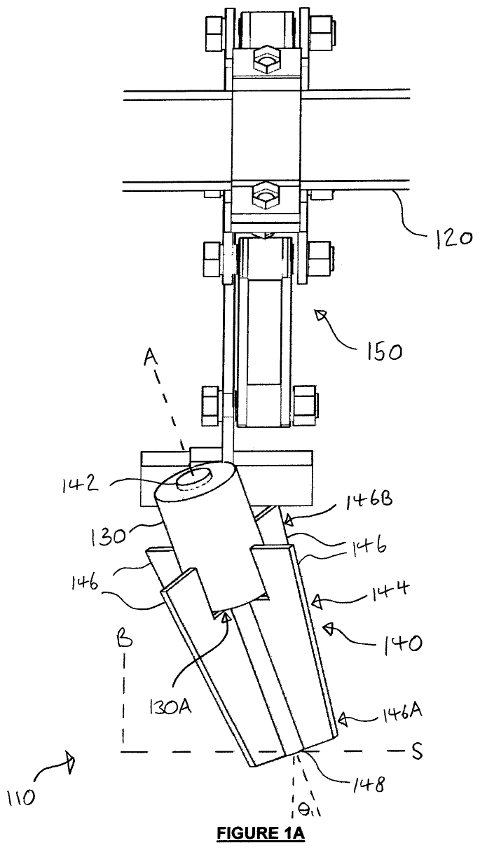

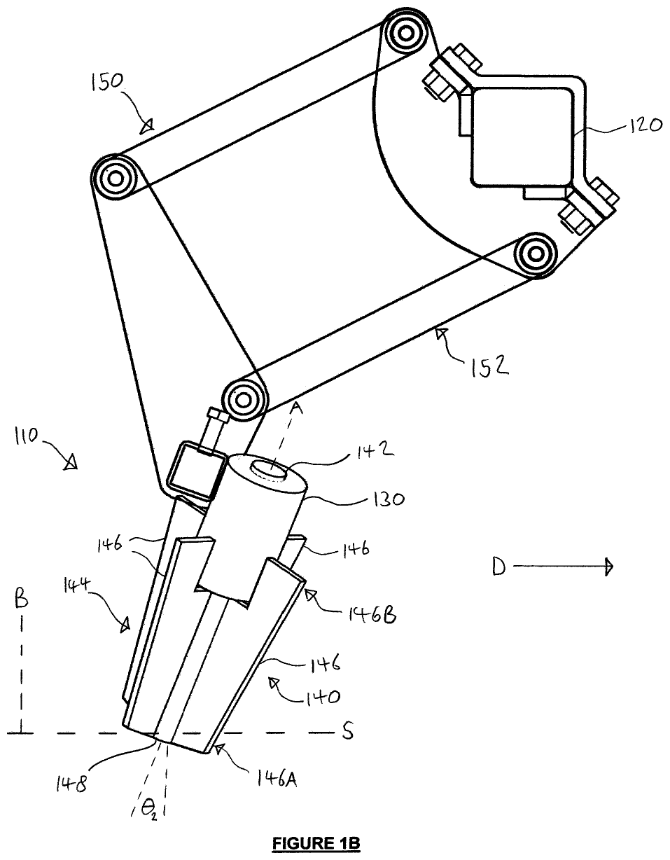

FIGS. 1A-1B show a scraperless trash clearing assembly 110 mounted to a horizontally extending member 120 of a towable frame supporting a cultivating or seed sowing implement and operative to clear trash (e.g., crop residue or weeds) from a soil surface “S” when driven across the soil surface in a direction of travel “D.”

Trash clearing assembly 110 comprises: a support in the form of a cylindrical bearing housing 130; a soil-engaging member or “rota” 140 freely rotatably mounted in the bearing housing 130 via an end shaft 142; and a ground tracking trailing arm assembly 150 operative to pivotally connect bearing housing 130 to horizontally extending member 120.

As illustrated in FIG. 1A, soil-engaging member 140 is oriented to rotate about a near vertical axis “A” tilted from a perpendicular to the soil surface “B” by an first acute angle θ1 towards one lateral side relative to the direction of travel “D.” This slightly offset angle results in contact between the soil-engaging member 140 and the soil surface inducing rotation of the soil-engaging member 140 around the axis “A.” As illustrated in FIG. 1B, axis “A” is further tilted by a second acute angle θ2 in a forward direction relative to the direction of travel “D” such that contact with the soil surface occurs forward of the center of rotation in the direction of travel thereby ensuring smooth operation. In this example, the first and second acute angles θ1, θ2 are substantially identical and each substantially 20°.

Soil-engaging member 140 defines a trash displacement surface 144 operative in use to displace trash to one lateral side of the assembly 110 relative to the direction of travel “D,” and additionally, to deflect trash attempting to rise up the soil-engaging member 140 downwards and sideways and away from bearing housing 130/trailing arm assembly 150.

Trash displacement surface 144 is provided by four substantially equally circumferentially-spaced vanes 146 extending radially from a central stem 148. The vanes 146 have a radial length that increases in length from a lower portion of the vane 146A to an upper portion of the vane 146B to define a frusto-conical outer profile when under rotation. This frusto-conical outer profile defines an area of revolution around axis “A,” which steadily increases with distance from the lower portion. As illustrated, the upper portions of the vanes 146B are sufficiently radially extended to enclose a leading portion 130A of bearing housing 130.

Trailing arm assembly 150 comprises a parallel linkage 152 operative to allow the soil-engaging member 140 to follow the ground contour variation while maintaining a predetermined orientation of the axis “A” relative to the ground. The trailing arm assembly 150 may be configured to provide a biasing action (e.g., using a spring, hydraulic, or pressurized air biasing device—not shown) to maintain a downward force on soil-engaging member 140 in order to maintain suitable ground pressure to ensure dependable ground-driven rotation.

The geometry of soil-engaging member 140 is designed such that the width at the lower ground contact point sufficient to induce a rotation action due to the ground contact being offset from the center line of the pivot axis “A”—typically upwards from 30 mm. This offset from the center line could be formed by any solid part of the circumference such as the shaft, tube or cone being large enough to be sufficiently offset to induce rotation. However, the inclusion of projecting vanes 146 has been found to be particularly effectively since the projections assist rotation and trash engagement.

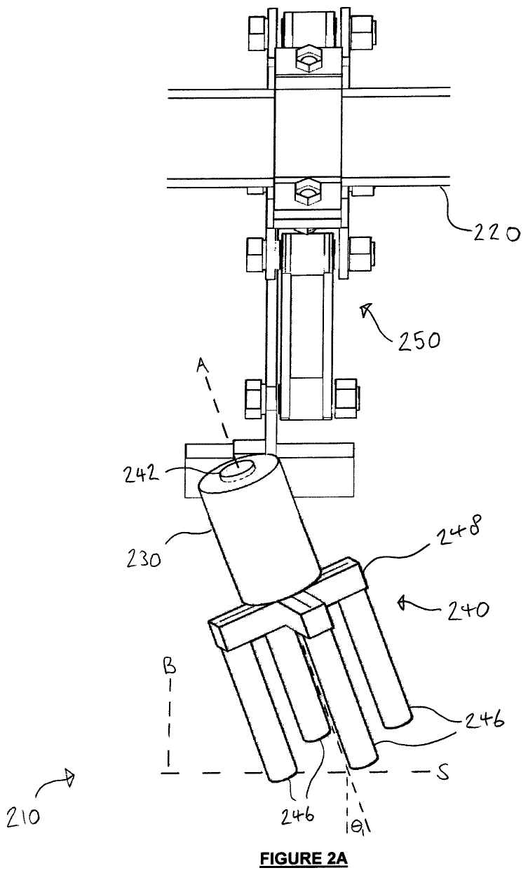

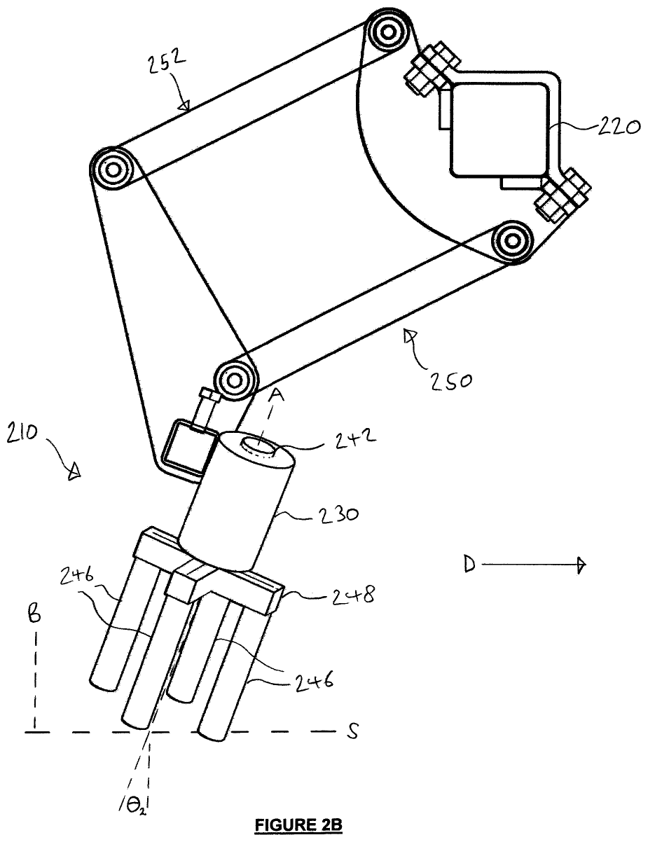

FIGS. 2A-2B show a scraperless trash clearing assembly 210 mounted to a horizontally extending member 220 of a towable frame supporting a cultivating or seed sowing implement and operative to clear trash (e.g., crop residue or weeds) from a soil surface “S” when driven across the soil surface in a direction of travel “D.”

Trash clearing assembly 210 comprises: a support in the form of a cylindrical bearing housing 230; a soil-engaging member or “rota” 240 freely rotatably mounted in the bearing housing 230 via an end shaft 242; and a ground tracking trailing arm assembly 250 operative to pivotally connect bearing housing 230 to horizontally extending member 220.

As illustrated in FIG. 2A, soil-engaging member 240 is oriented to rotate about a near vertical axis “A” tilted from a perpendicular to the soil surface “B” by an first acute angle θ1 towards one lateral side relative to the direction of travel “D.” This slightly offset angle results in contact between the soil-engaging member 240 and the soil surface inducing rotation of the soil-engaging member 240 around the axis “A.” As illustrated in FIG. 2B, axis “A” is further tilted by a second acute angle η2 in a forward direction relative to the direction of travel “D” such that contact with the soil surface occurs forward of the center of rotation in the direction of travel thereby ensuring smooth operation. In this example, the first and second acute angles θ1, θ2 are substantially identical and each substantially 20°.

Soil-engaging member 240 defines a trash displacement surface 244 operative in use to displace trash to one lateral side of the trash-clearing assembly 210 relative to the direction of travel “D,” and additionally, to deflect trash attempting to rise up the soil-engaging member 240 downwards and sideways and away from bearing housing 230/trailing arm assembly 250.

Trash displacement surface 244 comprises four substantially equally circumferentially-spaced axially extending tines 246 extending downwardly from a cruciform upper support frame 248.

As in the first embodiment, trailing arm assembly 250 comprises a parallel linkage 252 operative to allow the soil-engaging member 240 to follow the ground contour variation while maintaining a predetermined orientation of the axis “A” relative to the ground. Again, the trailing arm assembly 250 may be configured to provide a biasing action (e.g., using a spring, hydraulic, or pressurized air biasing device - not shown) to maintain a downward force on soil-engaging member 240 in order to maintain suitable ground pressure to ensure dependable ground-driven rotation.

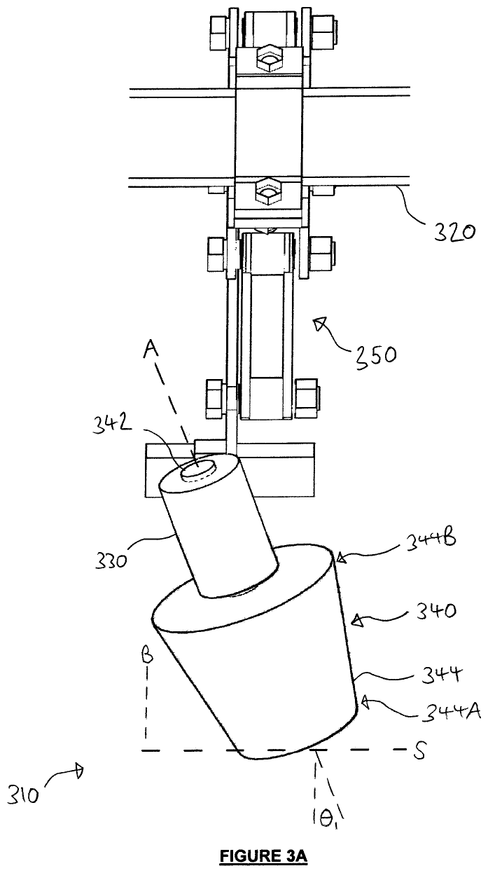

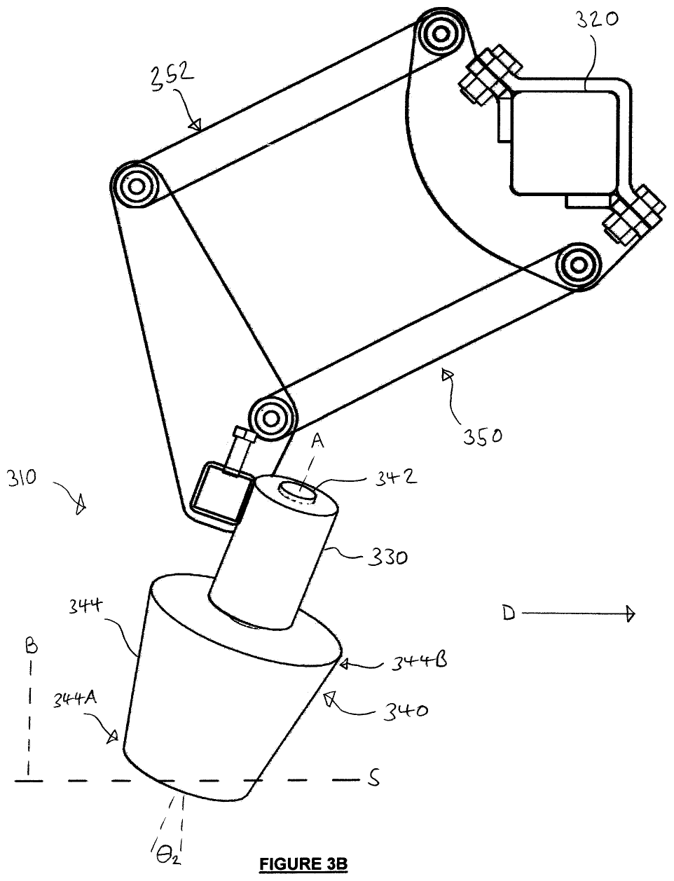

FIGS. 3A-3B show a scraperless trash clearing assembly 310 mounted to horizontally extending member 320 of a towable frame supporting a cultivating or seed sowing implement and operative to clear trash (e.g., crop residue or weeds) from a soil surface “S” when driven across the soil surface in a direction of travel “D.”

Trash clearing assembly 310 comprises: a support in the form of a cylindrical bearing housing 330; a soil-engaging member or “rota” 340 freely rotatably mounted in the bearing housing 330 via an end shaft 342; and a ground tracking trailing arm assembly 350 operative to pivotally connect bearing housing 330 to horizontally extending member 320.

As illustrated in FIG. 3A, soil-engaging member 340 is oriented to rotate about a near vertical axis “A” tilted from a perpendicular to the soil surface “B” by an first acute angle θ1 towards one lateral side relative to the direction of travel “D.” This slightly offset angle results in contact between the soil-engaging member 340 and the soil surface inducing rotation of the soil-engaging member 340 around the axis “A.” As illustrated in FIG. 1B, axis “A” is further tilted by a second acute angle θ2 in a forward direction relative to the direction of travel “D” such that contact with the soil surface occurs forward of the center of rotation in the direction of travel thereby ensuring smooth operation. In this example, the first and second acute angles θ1, θ2 are substantially identical and each substantially 20°.

Soil-engaging member 340 defines a continuous frusto-conical trash displacement surface 344 oriented such that the cross-sectional area of the frusto-conical surface increases from a lower portion 344A to an upper portion 344B. In use, trash displacement surface 344 is operative in use to displace trash to one lateral side of the assembly 310 relative to the direction of travel “D,” and additionally, to deflect trash attempting to rise up the soil-engaging member 340 downwards and sideways and away from bearing housing 330/trailing arm assembly 350.

As in the first embodiment, trailing arm assembly 350 comprises a parallel linkage 352 operative to allow the soil-engaging member 340 to follow the ground contour variation while maintaining a predetermined orientation of the axis “A” relative to the ground. As before, the trailing arm assembly 350 may be configured to provide a biasing action (e.g., using a spring, hydraulic, or pressurized air biasing device—not shown) to maintain a downward force on soil-engaging member 340 in order to maintain suitable ground pressure to ensure dependable ground-driven rotation.

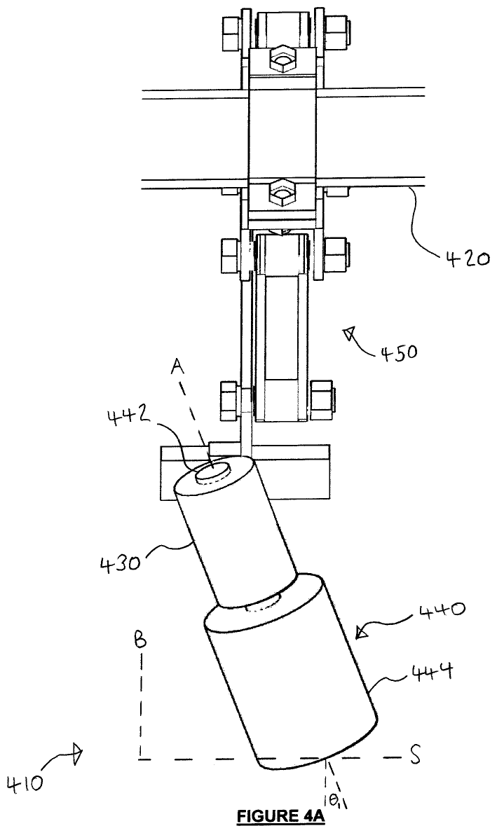

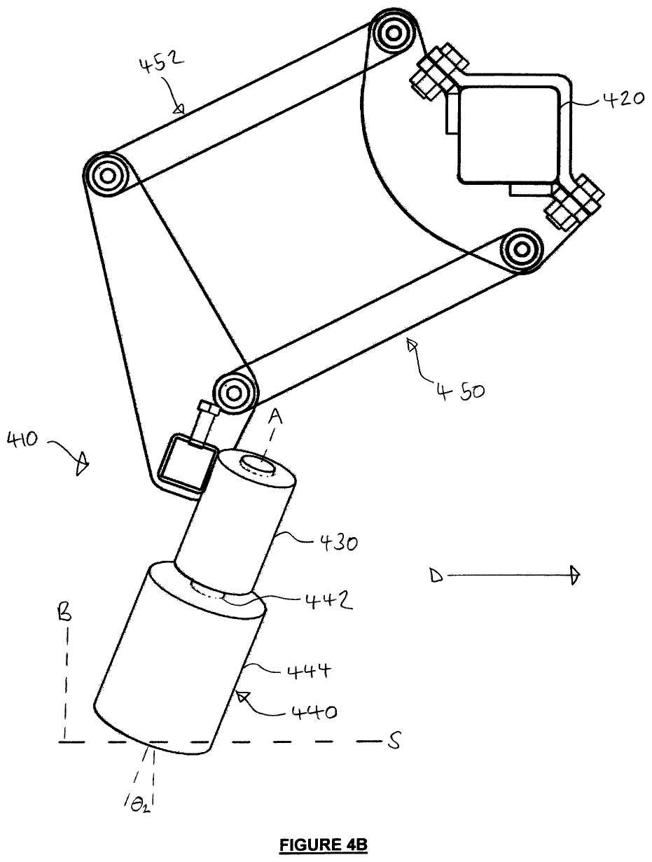

FIGS. 4A-4B show a scraperless trash clearing assembly 410 mounted to a horizontally extending member 420 of a towable frame supporting a cultivating or seed sowing implement and operative to clear trash (e.g., crop residue or weeds) from a soil surface “S” when driven across the soil surface in a direction of travel “D.”

Trash clearing assembly 410 comprises: a support in the form of a cylindrical bearing housing 430; a soil-engaging member or “rota” 440 freely rotatably mounted in the bearing housing 430 via an end shaft 442; and a ground tracking trailing arm assembly 450 operative to pivotally connect bearing housing 430 to a horizontally extending member 420.

As illustrated in FIG. 4A, soil-engaging member 440 is oriented to rotate about a near vertical axis “A” tilted from a perpendicular to the soil surface “B” by an first acute angle θ1 towards one lateral side relative to the direction of travel “D.” This slightly offset angle results in contact between the soil-engaging member 440 and the soil surface inducing rotation of the soil-engaging member 440 around the axis “A.” As illustrated in FIG. 1B, axis “A” is further tilted by a second acute angle θ2 in a forward direction relative to the direction of travel “D” such that contact with the soil surface occurs forward of the center of rotation in the direction of travel thereby ensuring smooth operation. In this example, the first and second acute angles θ1, θ2 are substantially identical and each substantially 20°.

Soil-engaging member 440 defines a continuous cylindrical trash displacement surface 444 operative in use to displace trash to one lateral side of the assembly 410 relative to the direction of travel “D.” The cylindrical trash displacement surface 444 has a cross-sectional area that is greater than that of bearing housing 430 (and accordingly a greater area of revolution around axis “A”) to assist the deflection of trash attempting to rise up the soil-engaging member.

As in the first embodiment, trailing arm assembly 450 comprises a parallel linkage 452 operative to allow the soil-engaging member 440 to follow the ground contour variation while maintaining a predetermined orientation of the axis “A” relative to the ground. As before, the trailing arm assembly 450 may be configured to provide a biasing action (e.g., using a spring, hydraulic, or pressurized air biasing device—not shown) to maintain a downward force on soil-engaging member 440 in order to maintain suitable ground pressure to ensure dependable ground-driven rotation.

In the embodiments of FIGS. 3A-3B and FIGS. 4A-4B, the soil-engaging members 340, 440 may be solid or hollow in construction. In the case of a hollow construction, the soil-engaging members 340, 440 may have a closed base (e.g., to prevent ingress of soil into the hollow rotary cylinder) or an open base (e.g., open-ended cylinder) that will allow some ingress of soil into the hollow cylinder.

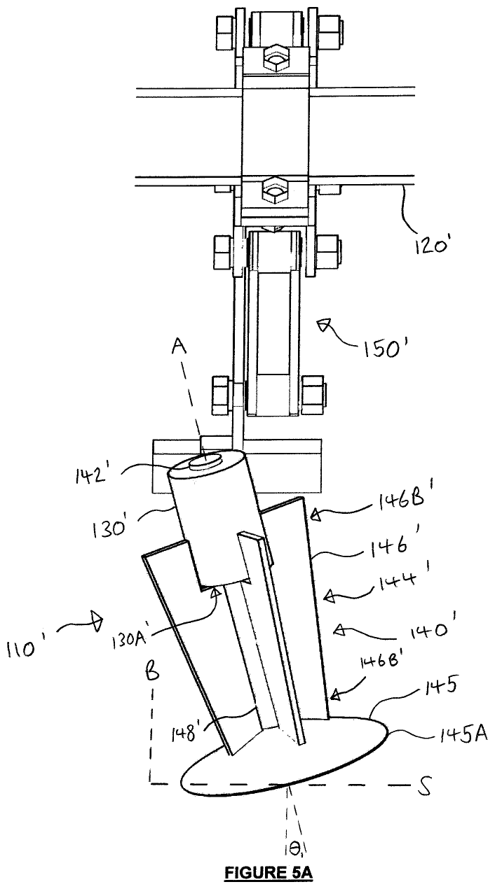

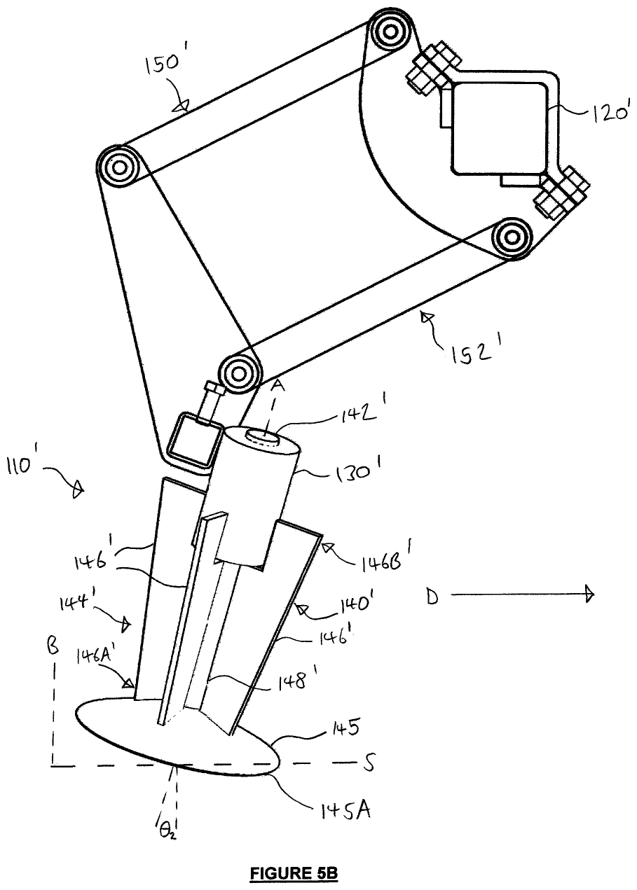

FIGS. 5A-5B show a scraperless trash clearing assembly 110′ based on the trash clearing assembly 110 of FIGS. 1A-1B (features in common are labelled accordingly). Assembly 110′ differs from 110 in that a lowermost part of the trash displacement surface 144′ comprises a domed circular cutting plate 145 with a convex upper profile and defining a protuberant cutting rim 145A projecting from a central body portion of the member and configured to partially penetrate the soil to a pre-defined first depth.

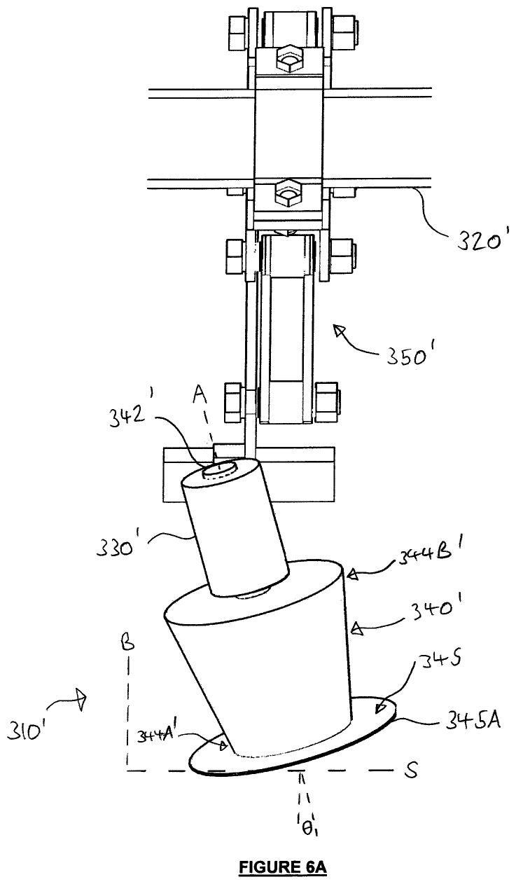

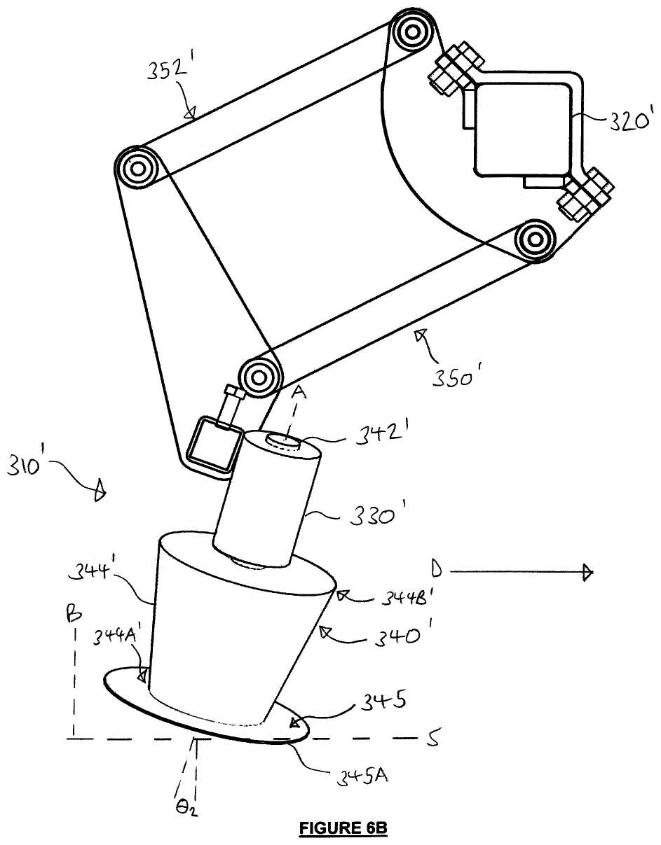

FIGS. 6A-6B show a scraperless trash clearing assembly 310′ based on the trash clearing assembly 310 of FIGS. 3A-3B (features in common are labelled accordingly). Assembly 310′ differs from 310 in that a lowermost part of the trash displacement surface 344′ comprises a flat circular cutting plate 345 defining a protuberant cutting rim 345A projecting from a central body portion of the member and configured to partially penetrate the soil to a predefined first depth.

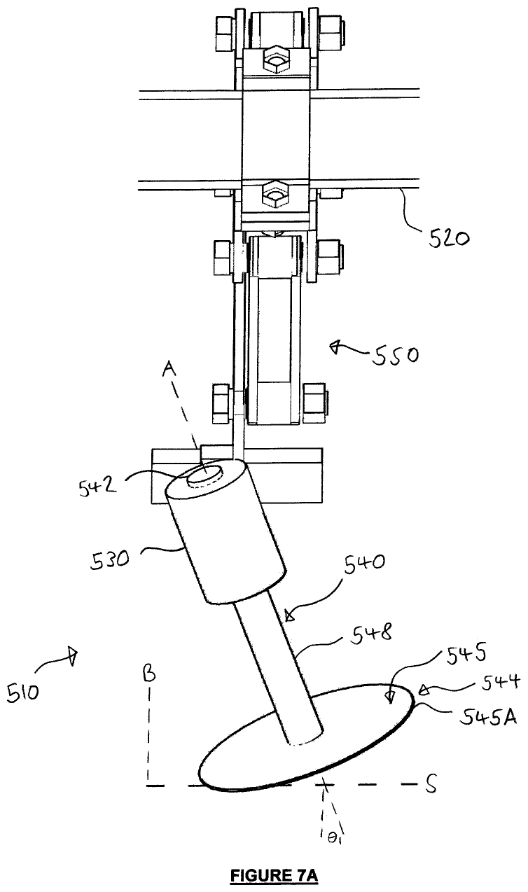

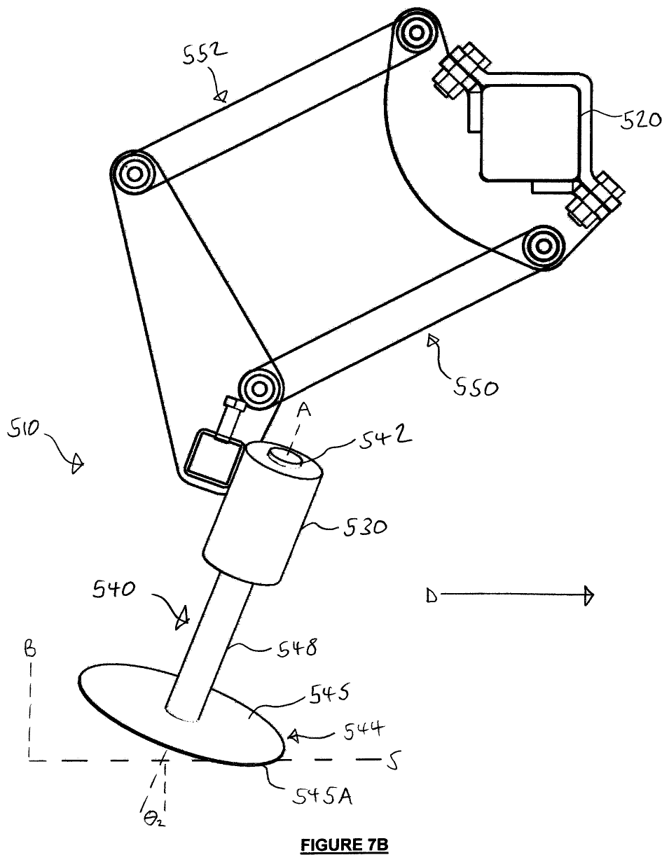

FIGS. 7A-7B show a scraperless trash clearing assembly 510 mounted to a horizontally extending member 520 of a towable frame supporting a cultivating or seed sowing implement and operative to clear trash (e.g., crop residue or weeds) from a soil surface “S” when driven across the soil surface in a direction of travel “D.”

Trash clearing assembly 510 comprises: a support in the form of a cylindrical bearing housing 530; a soil-engaging member or “rota” 540 freely rotatably mounted in the bearing housing 530 via an end shaft 542; and a ground tracking trailing arm assembly 550 operative to pivotally connect bearing housing 530 to a horizontally extending member 520.

As illustrated in FIG. 7A, soil-engaging member 540 is oriented to rotate about a near vertical axis “A” tilted from a perpendicular to the soil surface “B” by an first acute angle θ1 towards one lateral side relative to the direction of travel “D.” This slightly offset angle results in contact between the soil-engaging member 540 and the soil surface inducing rotation of the soil-engaging member 540 around the axis “A.” As illustrated in FIG. 1B, axis “A” is further tilted by a second acute angle θ2 in a forward direction relative to the direction of travel “D” such that contact with the soil surface occurs forward of the center of rotation in the direction of travel thereby ensuring smooth operation. In this example, the first and second acute angles θ1, θ2 are substantially identical and each substantially 20°.

Soil-engaging member 540 defines a trash displacement surface 544 at a lowermost portion of the soil-engaging member 540 operative in use to displace trash to one lateral side of the assembly 510 relative to the direction of travel “D.” Trash displacement surface 544 comprises a flat circular cutting plate 545 defining a protuberant cutting rim 545A projecting from a central body portion of the member and configured to partially penetrate the soil to a pre-defined first depth. As illustrated, trash displacement surface 544 is separated from bearing housing 530 by an elongate central stem 548.

As in the previous embodiments, trailing arm assembly 550 comprises a parallel linkage 552 operative to allow the soil-engaging member 540 to follow the ground contour variation while maintaining a predetermined orientation of the axis “A” relative to the ground. As before, the trailing arm assembly 550 may be configured to provide a biasing action (e.g., using a spring, hydraulic, or pressurized air biasing device—not shown) to maintain a downward force on soil-engaging member 540 in order to maintain suitable ground pressure to ensure dependable ground-driven rotation.

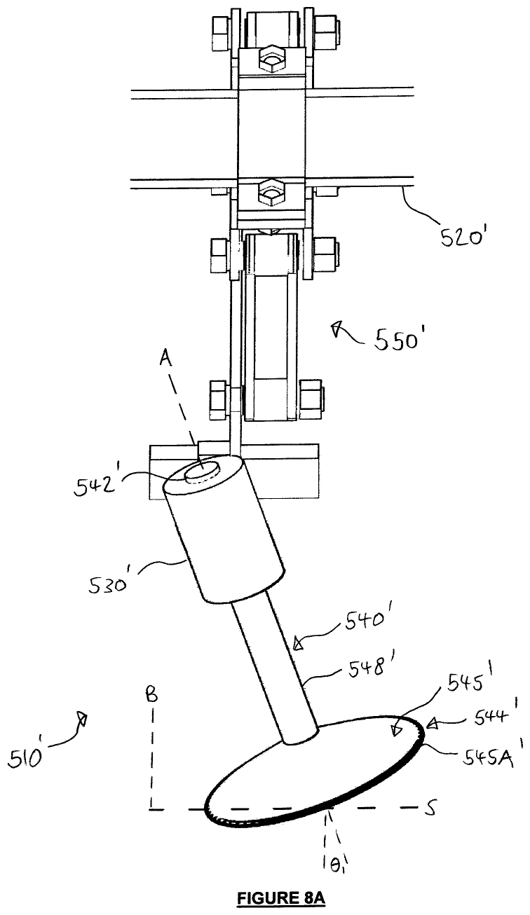

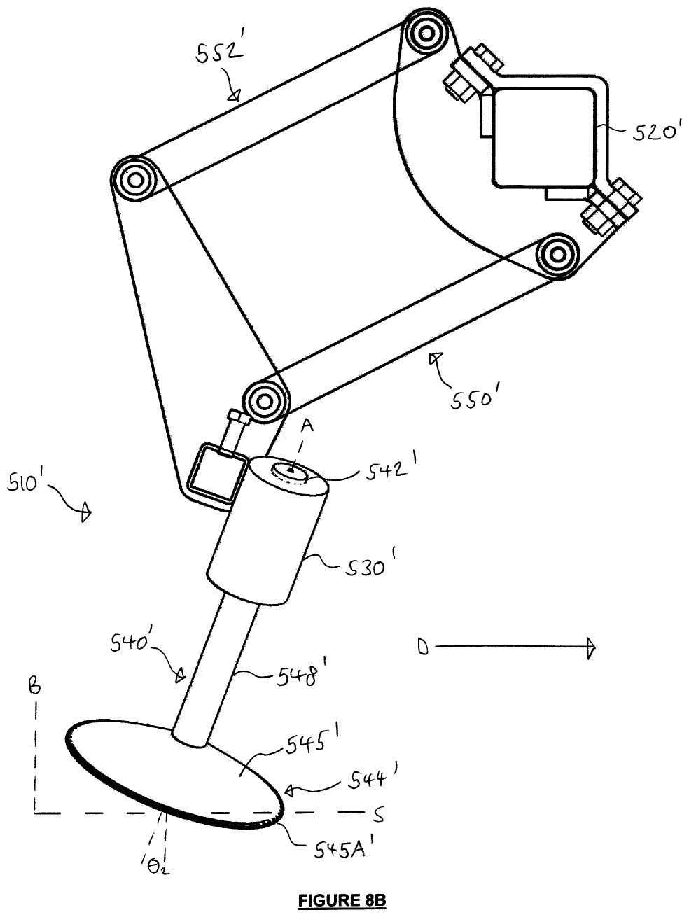

FIGS. 8A-8B show a scraperless trash clearing assembly 510′ based on the trash clearing assembly 510 of FIGS. 7A-7B (features in common are labelled accordingly). Assembly 510′ differs from 510 in that flat circular cutting plate 545 is replaced by a domed plate 545′ having a convex rather than flat upper profile.

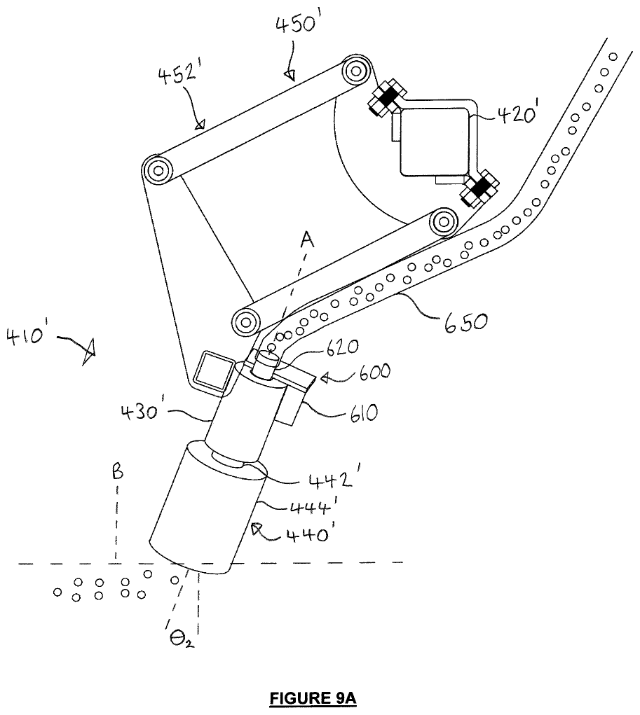

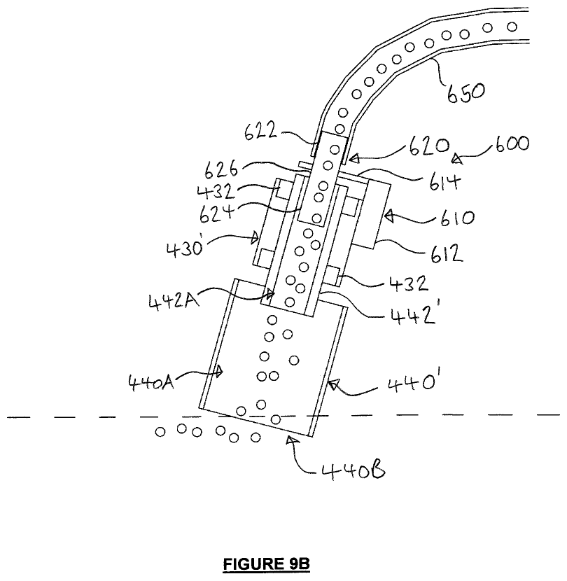

FIGS. 9A-9B show a scraperless trash clearing assembly 410′ based on the trash clearing assembly 410 of FIGS. 4A-4B (features in common are labelled accordingly).

As illustrated in FIG. 9B, scraperless trash clearing assembly 410′ differs from scraperless trash clearing assembly 410 in that end shaft 442′ and rotary body of soil-engaging member 440′ define first and second connected passageways 442A and 440A. A connector 600 comprising a bracket 610 and a hollow connecting tube 620 is provided to mount a flexible delivery tube 650 to bearing housing 430′ (FIG. 9B shows bearings 432 of bearing housing 430′). As shown, connecting tube 620 is positioned with an upper end 622 inserted into flexible delivery tube 650 and a lower end 624 inserted into first passageway 442A. Bracket 610 has a first end 612 mounted to bearing housing 430′ and a second end 614 connected to a central part 626 of connecting tube 620.

Together first and second passageways 442A, 440A define a delivery passageway for delivering material (e.g., particulate material such as seed or fertilizer or a liquid from a supply) to an outlet 440B provided at a lowermost portion of soil-engaging member 440′.

Although the material delivery functionality has been illustrated in the context of a trash clearing assembly based on the trash clearing assembly 410 of FIGS. 4A-4B, the skilled person will understand that the same material supply arrangement may be implemented with any of the other disclosed trash clearing assemblies by use of a hollow shaft/hollow shaft and hollow rotary body. Accordingly, the disclosure of the material supply arrangement is not intended to be limited to the specific trash clearing assembly 410′.

1. An apparatus for clearing trash from a soil surface, the apparatus being configured to be mounted on a towable frame support and driven across the soil surface in a direction of travel, the apparatus comprising:
a support; and
a soil-engaging member rotatably mounted to the support, wherein the soil-engaging member is oriented to rotate about an axis tilted from a perpendicular to the soil surface by an acute angle towards one lateral side relative to the direction of travel, whereby contact between the soil-engaging member and the soil surface induces rotation of the soil-engaging member around the axis.

2. The apparatus of claim 1, wherein the acute angle is in the range 10°-35°.

3. The apparatus of claim 1, wherein the axis is additionally tilted at a second acute angle towards the front relative to the direction of travel.

4. The apparatus of claim 3, wherein the second acute angle is in the range of 10°-35°.

5. The apparatus of claim 1, wherein the soil-engaging member comprises a central shaft.

6. The apparatus of claim 5, wherein the support comprises a bearing housing comprising a bearing, which rotatably supports an end part of the central shaft of the soil-engaging member.

7. The apparatus of claim 5, wherein the central shaft defines a passageway for delivering material to an outlet.

8. The apparatus of claim 7, wherein the central shaft defines an inlet for receiving material from a delivery tube.

9. The apparatus of claim 8, wherein the apparatus further comprises a connector for connecting the delivery tube to the support or to the soil-engaging member.

10. The apparatus of claim 1, wherein the soil-engaging member defines a trash displacement surface operative to displace trash to one lateral side relative to the direction of travel.

11. The apparatus of claim 10, wherein the trash displacement surface is configured to deflect away trash attempting to rise up the soil-engaging member.

12. The apparatus of claim 11, wherein the trash displacement surface extends from a lower portion of the body to an upper portion adjacent the support.

13. The apparatus of claim 12, wherein an upper portion of the trash displacement surface longitudinally overlaps a leading portion of the support.

14. The apparatus of claim 11, wherein the trash displacement surface has an area of revolution that increases with reduced distance from the support.

15. The apparatus of claim 1, wherein the trash displacement surface is a continuous surface.

16. The apparatus of claim 15, wherein the trash displacement surface is a substantially cylindrical surface.

17. The apparatus of claim 15, wherein the trash displacement surface is a frusto-conical surface.

18. The apparatus of claim 17, wherein the frusto-conical surface is orientated such that the cross-sectional area of the frusto-conical surface increases with reduced distance from the support.

19. The apparatus of claim 5, wherein the trash displacement surface comprises a plurality of circumferentially-spaced projections.

20. The apparatus of claim 19, wherein the soil-engaging member comprises a central shaft, and a lower part of the central shaft forms a central elongate stem and the trash displacement surface comprises a plurality of circumferentially-spaced vanes extending radially from the central stem.

21. The apparatus of claim 20, wherein the vanes have a radial length that increases with reduced distance from the support.

22. The apparatus of claim 19, wherein the trash displacement surface comprises a plurality of circumferentially spaced axially extending tines extending from a support frame.

23. The apparatus of claim 1, wherein a lowermost part of the soil-engaging member defines a protuberant cutting rim projecting from a central body portion of the member and configured to partially penetrate the soil.

24. The apparatus of claim 1, wherein the apparatus further comprises a trailing arm assembly mounted to the support and operative to allow the soil engaging member to follow ground contour variations.

25. The apparatus of claim 24, wherein the trailing arm assembly is operative to maintain a predetermined orientation of the axis relative to the ground.

26. The apparatus of claim 1, wherein the apparatus is biased to maintain a downward force on soil-engaging member.

27. A frame assembly for towing along a soil surface on which there is mounted apparatus for clearing trash as defined in claim 1.
